(19) United States
(12) Patent Application Publication
(10) Pub. No.: US 2008/0112571 A1
(43) Pub. Date: May 15, 2008

(54) NOISE CONTROL IN PROXIMITY TO A COMPUTER SYSTEM

(76) Inventors: Thomas Michael Bradicich, Apex, NC (US); Richard Edwin Harper, Chapel Hill, NC (US); William Joseph Piazza, Holly Springs, NC (US)

Correspondence Address: IBM CORPORATION (SS/NC);c/o STREETS & STEELE, 13831 NORTHWEST FREEWAY, SUITE 355, HOUSTON, TX, 77040, US

(21) Appl. No.: 11/558,069

(22) Filed: Nov. 9, 2006

(51) Int. Cl. H04R 3/02

(52) U.S. Cl. 381/73.1

(57) ABSTRACT

Methods and systems are provided for controlling sound level of a computer system within a selected zone. In one embodiment, the sound level within an enclosed space is detected and an electronic signal representative of the sound level is generated in response. The presence of one or more person within the enclosed space is detected, and an electronic signal is generated responsive to the detected presence. The airflow rate and processor load are both decreased in response to the detected presence when the sound level exceeds a predefined sound-level setpoint.

### BACKGROUND OF THE INVENTION

1. Field of the Invention

The present invention relates to controlling the noise produced by a computer system, such as a rack-based server system.

2. Description of the Related Art

Cooling systems for computers can produce sound levels sufficient to damage hearing from continued or repeated exposure. Rack-based server systems such as blade servers can be particularly noisy due to the combined use of multiple servers and blowers. As technology continues to advance, servers are becoming increasingly powerful and compact. Increasing power consumption generates more heat, which requires increasing air flow for proper cooling. Increased airflow generally translates to greater noise levels. Potentially harmful noise levels are therefore one disadvantage of modern computer systems having conventional forced air cooling systems. Noise levels generated by computer systems have prompted the creation of safety regulations that limit the amount of noise that these computer systems are allowed to generate. Unfortunately, limiting or reducing the amount of airflow through the computer system requires reducing processor load, causing the computer to run at less than its full processing capacity.

Therefore, a solution is needed for controlling sound levels of computer systems. A desirable solution would preferably prevent damaging levels of noise in the vicinity of a computer, while simultaneously allowing a computer system to run more closely to its maximum processing capacity, to optimize the performance of the computer system. It is particularly desirable that such a solution could be implemented on the existing installed base of computer systems and did not require any extensive redesign of the computer hardware.

### SUMMARY OF THE INVENTION

In a first embodiment, a method is provided for controlling sound level within a predetermined distance from a computer system. Sound level within the predetermined distance from the computer system is detected and an electronic signal representative of the sound level is generated. The presence of one or more person within the predetermined distance from the computer system is detected, and an electronic signal representative of the detected presence is generated. An airflow rate through the computer system and a processor load are decreased in response to the electronic signal representative of the detected presence when the electronic signal representative of the sound level indicates that the sound level exceeds a predefined sound-level setpoint.

In a second embodiment, a system is provided for controlling sound level within a predetermined distance from a computer system. The computer system has one or more blowers and one or more processors. A sound level sensor is positioned within the predetermined distance from the computer system for generating an electronic signal representative of sound level within the predetermined distance from the computer system. A position sensor is provided for generating an electronic signal responsive to the presence or motion of a person within the predetermined distance from the computer system. A controller is in electronic communication with the sound level sensor and the position sensor. The controller controls the one or more blowers and the one or more processors and selectively decreases an airflow rate and a processor load in response to both the signal from the sound level detector and the signal from the position detector.

In a third embodiment, a computer program product has a computer usable medium including computer usable program code for controlling sound level within a predetermined distance from a computer system. Computer usable program code is included for detecting sound level within a predetermined distance from the computer system and generating an electronic signal representative of the sound level. Computer usable program code is included for detecting the presence of one or more person within the predetermined distance from the computer system and generating an electronic signal responsive to the detected presence. Computer usable program code is included for decreasing an airflow rate through the computer system and decreasing a processor load in response to the detected presence when the sound level exceeds a predefined sound-level setpoint.

### BRIEF DESCRIPTION OF THE DRAWINGS

FIG. 1 is a partially cutaway perspective view of a representative computer system that may be configured according to the invention.

FIG. 2 is a graph that qualitatively illustrates the relationship between the processor load of a computer system and the net airflow rate (Qₙₑₜ) required to cool the computer system.

FIG. 3 is a graph that qualitatively illustrates the relationship between the net airflow Qₙₑₜ and the sound level (dB) of a computer system.

FIG. 4 is a schematic plan view of a computer installation according to the invention for controlling sound level within a computer room, wherein position sensors are used to detect human presence.

FIG. 5 is a schematic diagram of an alternative embodiment of a computer installation according to the invention for controlling sound level within a computer room, wherein a plurality of pressure sensing pads are used to detect a sequence of motion indicative of human presence.

FIG. 6 is a schematic plan view of a computer installation according to the invention having device-specific and group-specific position sensors for individually controlling noise levels of various components within a computer room, as part of a noise-reduction mode of operation.

FIG. 7 is a schematic diagram illustrating one possible operational configuration of a controller for receiving position-related and sound-related signals and selectively controlling airflow parameters in response, as part of a noise-reduction mode of operation.

FIG. 8 is a flowchart of a method of controlling sound level within a predetermined distance from a computer system, and optionally in an enclosed space about the computer system, as part of a noise-reduction mode of operation.

### DETAILED DESCRIPTION OF PREFERRED EMBODIMENTS

The present invention is directed to detecting human presence and controlling sound levels generated by a computer system in response to the detected human presence. The present invention includes embodiments for automatically controlling sound levels in a computer room, generally, as well as embodiments for automatically controlling sound levels in proximity to specific components or component groups of the computer system. If a sound level exceeds a predefined setpoint, the computer system enters a noise reduction mode. In the noise reduction mode, airflow through the computer system's enclosure or through a specific electronic component or group of electronic components may be selectively reduced, such as by reducing the rotational speed of fans associated with the component(s). The temperature of the component(s) may be monitored, and processor load may be reduced if it is determined that the reduced airflow poses a risk of overheating the component(s). The computer system may continue to operate in the noise reduction mode for as long as the human presence is detected. When the computer system no longer detects human presence, the computer system may exit the noise reduction mode, allowing processor loads and airflow to increase. When the computer system is not operating in the noise reduction mode, sound levels (such as those caused by airflow and fan operation) are allowed to exceed the predefined setpoint. By operating the computer system or its components closer to a maximum processor capacity when people are not in the room, the computer system may achieve greater productivity.

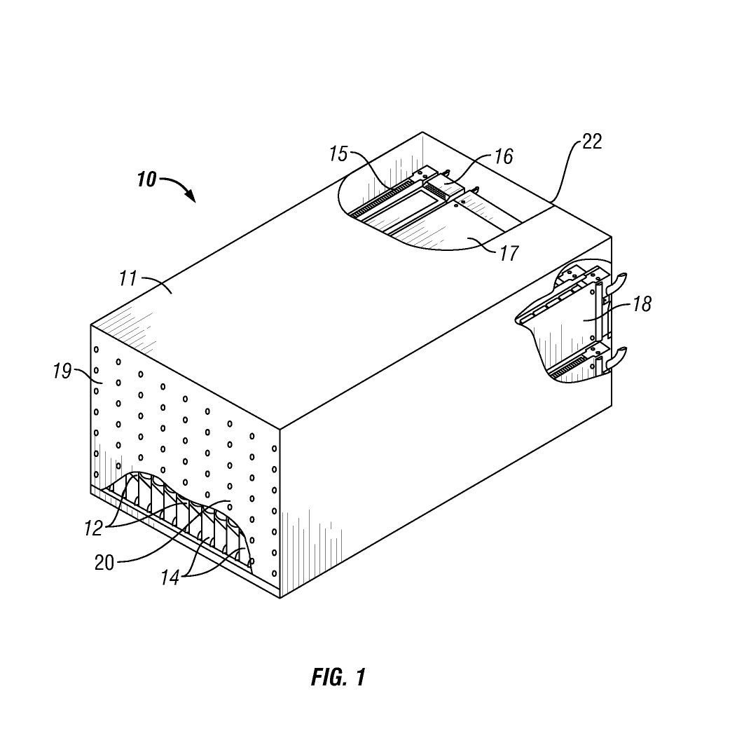

FIG. 1 is a partially cutaway perspective view of a representative rack server system (“computer system”) 10 that may be configured according to the invention. The computer system 10 includes an enclosure 11 housing multiple servers 12 and intake vents 14. The servers 12 may be single or multi-processor servers having hard drives and memory to service one or more common or independent networks. In this embodiment, the servers 12 are “blade” type servers, though the invention is also useful with other types of rack-mounted server systems, as well as with other computer systems having electronic components in an enclosure. The enclosure 11 also houses many other components, such as a management controller module 15, a power module 16, at least one blower 17, and a switch module 18. The multiple servers 12 may share the management controller 15, power module 16, blower 17, and switch module 18, as well as other support modules housed within the enclosure 11. In many embodiments, connectors may couple the servers 12 with the support modules to reduce wiring requirements and facilitate installation and removal of the servers 12. For instance, each server 12 may couple with a gigabit Ethernet network via the switch module 18. The enclosure 11 may couple the servers 12 to the Ethernet network without connecting individual cables directly to each server. The enclosure 11 may also include a grillwork 19.

The blower 17 generates forced air convection to remove some of this heat to cool the computer system 10. In this embodiment, the blower 17 draws air into the front 20 of the enclosure 11, through the servers 12 and other heat-generating components, and exhausts the heated air through the rear 22 of the enclosure 11, where the heated air mixes with ambient air. The net airflow rate (Qₙₑₜ) in the computer system 10 is from the front 20 to the rear 22 of the enclosure 11, although numerous airflow paths are typically present within the enclosure 11. The net airflow may be adjusted to control the level of cooling.

The servers 12 and other components generate heat within the computer system 10. The amount of heat that the servers 12 generate correlates with the processor load. Processor load also generally corresponds to throughput and may include such factors as processor speed, clock speed, bus speed, the number of individual processors recruited for performing a task, and so forth. Processor load may be measured by such metrics as MIPS (“million instructions per second”) or teraflops. Processor load may also be referred to in relative terms, such as “percentage of full processor utilization.”

Reducing processor load broadly includes any change to operation of the central processors (“CPUs”) that reduces overall power consumption, even if at the expense of computational performance. For example, power consumption may be reduced by “throttling” the central processor(s), placing subsystems into power-saving modes of operation, or powering off unused circuitry. Other examples of reducing processor load are reducing a clock frequency or operating voltage of one or more of the CPUs, or introducing wait or hold states into the activity of the CPUs.

The blower 17 generates sound levels that relate to factors such as the net airflow rate, velocity of individual airstreams, the movement of air through impeller blades and through numerous tortuous paths within the computer system, and the mechanical noise of an electric motor and a rotating impeller included with the blower 17. The sound level generally increases with increasing air flow rate. The blower 17 may have a variable blower speed for adjusting airflow. Increasing the blower speed may increase both the velocity of air moved by the blower 17 and the rotational speed of the impeller, increasing the sound level. The use of additional blowers may also increase sound levels. For example, the computer system 10 may include multiple blowers 17, each contributing to the sound level. The net airflow rate through the enclosure 11 may be controlled by controlling the speed of each blower 17, by controlling the number of blowers 17 recruited, or both. During periods of reduced processor load, the net airflow rate may be reduced by reducing the blower speed of one or more blowers or by turning off one or more of the blowers 17.

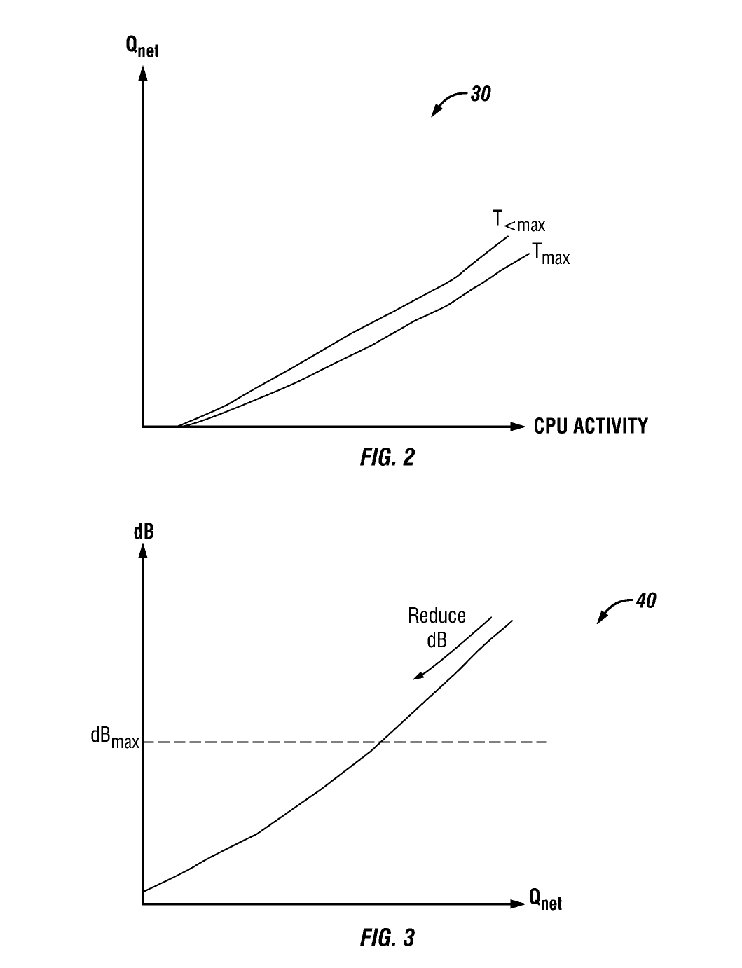

FIG. 2 is a graph 30 that qualitatively illustrates the relationship between the processor load of a computer system and the net airflow rate (Qₙₑₜ) required to cool the computer system. Generally, the amount of heat generated by a computer system increases with processor load. Therefore, increasing processor load generally requires increasing Qₙₑₜ to maintain proper cooling of the computer system. The graph includes two constant-temperature curves for two different temperatures Tₘₐₓ and T_{<max} to illustrate this relationship between processor load and Qₙₑₜ for given values of T. Tₘₐₓ is the maximum temperature at which the computer system is intended to be operated to minimize the risk of overheating. Tₘₐₓ may be determined theoretically or empirically. It is desirable to operate the computer system at a value less than Tₘₐₓ, as represented by the T<max curve. The operating temperature may be reduced by decreasing the processor load and/or increasing Qₙₑₜ.

FIG. 3 is a graph 40 that qualitatively illustrates the relationship between the net airflow Qₙₑₜ and the sound level (dB) of a computer system, such as the computer system 10 of FIG. 1. Generally, the sound level generated by a computer system increases with net airflow (Qₙₑₜ). A maximum sound level (dBₘₐₓ) may be selected, above which prolonged exposure may be harmful to human hearing. For example, the Occupational Safety and Health Administration (OSHA) dictates certain maximum sound levels for computer installations. The dBₘₐₓ may be associated with sound levels in a computer room generally, such as due to the combined noise of many blowers or other components. Alternatively, dBₘₐₓ may be device-specific, relating to the sound level of a particular electronic component or group of electronic components at a selected distance near the electronic component or group of electronic components. Many computer installations are capable of producing sound levels well in excess of the value of dBₘₐₓ. OSHA or other regulations may therefore require reducing noise levels. Qₙₑₜ is reduced to reduce sound level. As the graph of FIG. 2 demonstrates, reducing Qₙₑₜ may require a corresponding reduction in processor load to maintain a safe operating temperature. However, unless the processor is already operating at Tmax, an immediate reduction of the processor load is probably not necessary. FIG. 3 is a graph that qualitatively illustrates the relationship between the net airflow Qₙₑₜ and the sound level (dB) of a computer system. To achieve a sound level below dBmax, it may be necessary to reduce or limit the net airflow.

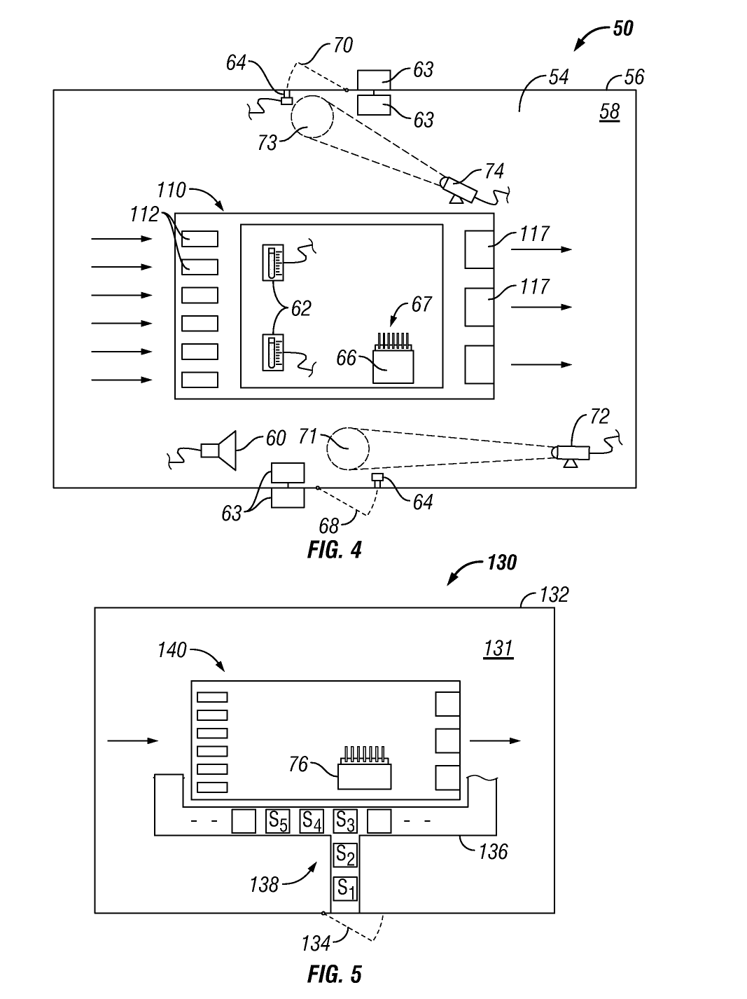

FIG. 4 is a schematic plan view of a computer installation 50 according to the invention that is able to detect human presence within a computer room 54 and automatically control sound levels in response. This embodiment is particularly useful for computer installations in which the overall noise level in the computer room 54 may exceed safety thresholds, such as due to the combined sound produced by multiple noise-generating components. The computer installation 50 includes a computer system 110 installed in the computer room 54. The entire computer room 54 may be treated as a “zone” of detection in this embodiment, such that human presence anywhere in the computer room 54 may trigger a noise-reduction mode. The computer system 110 may be similar to the computer system 10 of FIG. 1, and includes an enclosure 111 and a plurality of servers 112 and blowers 117 housed therein. A computer room 54 defines an enclosed space about the computer system 110. In this embodiment, the enclosed space includes walls 56, a floor 58, and an optional ceiling (not shown). Two doors 68, 70 provide entrances for people to enter and exit the computer room 54. The walls 56 may comprise an acoustically absorbent material, for absorbing sound and reducing transmission of sound through the walls 56. A value of dBₘₐₓ may be associated with the computer installation 50. The walls 56 may sufficiently dampen sound such that, even at a maximum airflow rate, sound levels caused by the computer system 110 are not bothersome, or are at least not harmful, to people outside the computer room 54.

Computer systems are frequently installed in enclosed spaces in order to control dust, air temperature and other environmental factors, including noise levels. The “enclosed space” aspect of the computer installation 50 does not require the computer room 54 to be completely closed, sealed or airtight. For example, the doors 68, 70 provide openings to the computer room 54. Ceiling tiles (not shown) and any gaps between the walls 56 are other potential pathways for air and sound to travel out of the enclosed computer room 54. However, the computer room 54 provides a sound barrier sufficient that sound levels caused by the computer system 110 are less than dBₘₐₓ outside the enclosed space even when sound levels inside the enclosed space are greater than dBₘₐₓ.

The computer installation 50 includes one or more optional sound level sensors 60, as well as temperature sensors 62, door sensors 64, presence sensors 72, 74, and a controller 66 that receives and processes electronic signals generated by all of the sound level sensors 60, temperature sensors 62, door sensor 64, and presence sensors 72, 74, and selectively controls processor load of the multiple servers 12 and the airflow rate of the blowers 17 in response. The controller 66 includes a plurality of sensor leads 67 which are in electronic communication with the various sensors 60, 62, 64, 72, 74 for receiving the electronic signals generated thereby. The controller 66 may be in electronic communication with the servers 12 and the blowers 17 through other electronic pathways in the computer system 110.

Temperature sensors 62 are typically included with the computer system 110 to provide temperature feedback used by the controller 66 to regulate temperature. The controller 66 may control the blowers 117 to control Qₙₑₜ and control the servers 112 to control processor load, for example, to maintain a safe operating temperature within the computer system 110. The controller 66 may selectively increase the airflow rate provided by the blowers 17 and/or selectively decrease the processor load of the servers 12, as needed, to increase cooling of the computer system 110.

The presence sensors 72, 74 may be configured to sense position, and/or a change in position (i.e. motion), at detection zones 71, 73, respectively. The presence sensors 72, 74 may, therefore, be any of a variety of position, proximity, or motion sensors known in the art. Some non-limiting examples of position sensors include sensors that detect interference with a laser or other light beam, IR motions sensors, and RF proximity sensors. For example, the presence sensor 72 may generate a light beam that focuses in the vicinity of detection zone 71 or is positioned near the detection zone 71. The presence sensor 72 generates a signal when a person or other object enters the detection zone 71. Typically, the “object” of concern is a human who has entered the computer room 54 through the door 68. The controller 66 may, therefore, be configured so that the positioning of any object in the detection zone 71 is assumed to be a person and to throttle the computer system 110 in response. Detecting human presence according to the invention, therefore, is not intended to imply or require a direct or incontrovertible determination that the object being sensed is an actual person or people. Rather, detecting human presence is intended to include detecting a condition that is consistent with human presence.

Though it is not necessary to confirm the sensed object is a person, some position sensors may provide more conclusive or selective determination of whether an object being sensed is a person. For example, the presence sensor 72 may be or include a temperature sensor targeted at the detection zone 71. The controller 66 may alternatively be configured so that if the presence sensor 72 detects a sudden temperature change within the detection zone 71 to within the normal range of human body temperature, the controller 66 assumes a person has entered the computer room 54. Because normal human body temperature is typically about 98.6 degrees Fahrenheit, a temperature range of interest may be between about 95 and 105 degrees Fahrenheit. Thus, the controller 66 may be configured to treat any temperature change in the detection zone 71 to within this temperature range to be indicative of human presence, and ignore temperature changes that fall outside this range.

A variety of other optical or non-optical position sensors and proximity sensors are known in the art that may be adapted for use with embodiments of the invention. For example, the position sensor could similarly be employed in the form of a pressure sensitive mat.

The distance of the presence sensor 72 from the detection zone 71 may vary depending on the type of the presence sensor 72, the configuration of the computer installation 50 generally, and the preferences and desires of a system designer. Though not required, some embodiments of position sensors, such as IR-, RF-, and laser-based position sensors desirably detect position/motion from a distance of several feet or more between the sensor and the detection zone. Other position sensors are triggered by very close proximity or even by direct mechanical contact of an object being sensed.

The door sensor 64 may be used alone or in conjunction with the presence sensor 72 to detect the presence of a person. Using the door sensor 64 and the presence sensor 72 in combination provides for a better verification of human presence. The door sensor 64 may be any of a variety of position sensors known in the art. In this embodiment, the door sensor 64 is specifically configured to detect an opening of the door 68. The door sensor 64 may be a switch that senses whether the door 68 is open or closed, and generates a signal in response. When a user opens the door 68 to enter the computer room 54, the door sensor 64 generates a signal that the controller 66 may interpret to be at least one indicator of human presence or entry into the computer room 54. The controller 66 may throttle the computer system 110 in response to one or both of a signal from the door sensor 64 indicating the opening of the door and a signal from the presence sensor 72 indicating the presence of a person in the computer room 54.

The presence sensor 72 may detect the presence of a person when the person is at a predetermined distance from the computer system 110. Thus, it is not necessary for the person to touch the computer system 110 before the computer system 110 is automatically throttled. For example, detection zones 71 and 73 are both spaced from the enclosure 111 of the computer system 110. The presence of the person may be detected and the computer system 110 may be throttled as early as the moment that the person steps into one of the detection zones 71, 73 to trigger one of the presence sensors 72, 74, or even as early as the moment that the person opens one of the doors 68, 70 to trigger one of the door sensors 64.

The door sensors 64 may optionally be used in conjunction with an optional subsystem used to track the number of people in the computer room 54. For example, optional ID stations 63 may be configured with the computer installation 50 requiring a person to swipe an ID in order to enter and/or exit the doors 68, 70. The controller 66 may keep track of whether any people are in the computer room 54 and activate the noise reduction mode whenever people are in the room.

FIG. 5 is a schematic diagram of an alternative embodiment of a computer installation 130 including a computer system 140, wherein a plurality of pressure sensing pads 138 are used to detect a sequence of motion indicative of human presence. The computer system 140 is enclosed in a room 132 having a door 134. The pressure sensing pads 138 may include any of a variety of pressure sensing members known in the art, configured to generate an electronic signal in response to an applied force or pressure. The pressure sensing pads 138, some of which are labeled for reference as S1-S5, are arranged along a walkway 136. The pressure sensing pads 138 may sit directly on a floor 131 and have a thickness that makes them noticeable to a person standing or walking on the pressure sensing pads 138. Alternatively, the pressure sensing pads 138 may be inconspicuously disposed under a carpet or other flooring surface. Electronic communication between the pressure sensing pads 138 and a controller 76 may be provided by wires (not shown) routed underneath pressure sensing pads 138. Although not required, the walkway 136 may be demarcated with paint and/or barriers intended to guide a person within the room 132, thus constraining the person to walk along the pads 138.

As a person opens the door 134 and walks along the walkway 136, the person will likely step on some of the pressure sensing pads 138 to reach the computer system 140. The signal generated in response to stepping on some number of the pads 138 is sent to the controller 76. The controller 76 may sense the presence of the person, as well as the person's position or movement within the room 132 based on the signals from the pads 138. The controller 76 may be configured to throttle the computer system 140 in response to a signal from any of the pressure sensing pads 138. Alternatively, the controller 76 may be configured to throttle the server system 140 only when a sequence of signals (e.g. S1, S2, S3) generated by the pressure sensing pads 138 match a predefined sequence. The predefined sequence may be selected by a system designer.

The use of pressure sensitive pads may be appropriate for some environments, such as a more traditional office environment having cubicles or other conventional work areas, and less well suited for other environments, such as a raised-floor data center. A raised-floor data center may incorporate the flow of cooling air through perforated floor tiles, typically in proximity to computer system equipment to be cooled. Thus, pressure sensitive pads could potentially obstruct the airflow in such an environment. Nevertheless, in some embodiments, the pressure sensitive pads could be placed on non-perforated portions of a floor that are still in close enough proximity to the computer system equipment to cause personnel to stand on the pads while accessing the equipment.

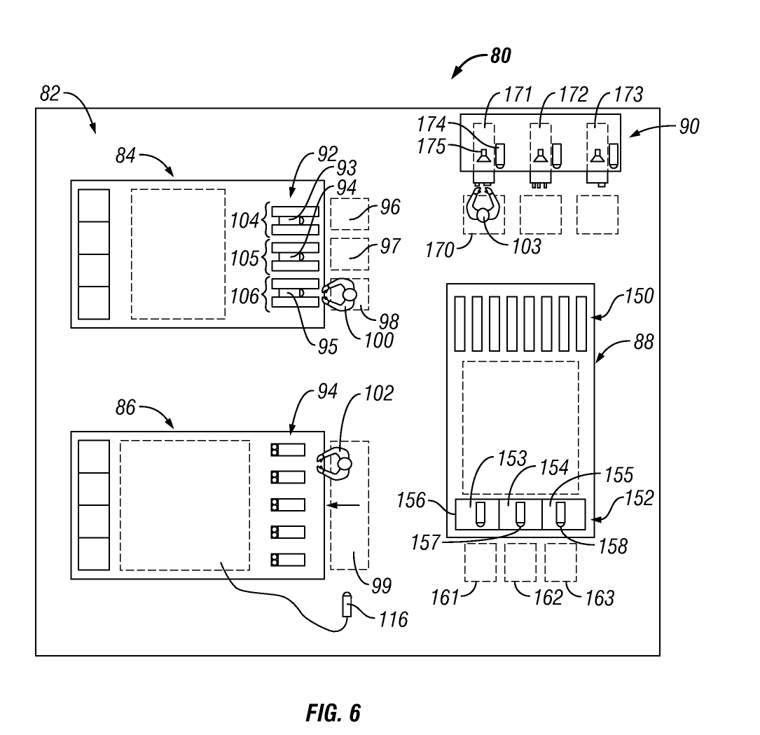

FIG. 6 is a schematic plan view of a computer installation 80 according to the invention having device-specific and group-specific presence sensors for individually controlling noise levels in proximity to specific components and component groups within a computer room 82. Such a system is particularly useful for computer installations wherein a specific component or component group is capable of generating potentially harmful sound levels over an area in close proximity to the component or component group. The computer installation 80 includes, by way of example, a six-server rack 84, a five-server rack 86, an eight-server rack 88, and an electronics panel 90, each having a different set of electronic components and a different sensor configuration for selectively controlling sound levels associated with the electronic components.

The six-server rack 84 includes six servers generally indicated at 92. Three group-specific presence sensors 93, 94, 95 are included, which may be any of the types of presence sensors discussed herein. The presence sensors 93-95 may be described as “group-specific” in that each presence sensor 93-95 is associated with a specific subset of the servers 92. In particular, a first server pair 104 is associated with the presence sensor 93, which is configured for sensing a user in a zone 96. A second server pair 105 is associated with the presence sensor 94, which is configured for sensing a user in a zone 97. A third server pair 106 is associated with the presence sensor 95, which is configured for sensing a user in a zone 98. Each of the servers 92 may include at least one CPU that may act as a controller for receiving signals from its associated presence sensor and controlling a fan speed, reducing a processor load, or both in response. In an alternative embodiment, a system controller may receive signals from all of the presence sensors 93-95, and individually control the associated server pairs 104-106 in response.

For example, a user 100 is shown standing in zone 98 in proximity to the server pair 106. The torso of user 100 approximately spans the server pair 106, and, accordingly, the zone 98 is optionally selected to span the server pair 106. Thus, the presence sensor 95 is configured to detect the presence of the user 100 when in the zone 98 and signal each of the servers of the server pair 106 to selectively reduce their respective fan speeds. If the user 100 were to move to the zone 97, the presence sensor 94 would detect the user's presence in the zone 97 and signal the server pair 105 to reduce their fan speeds in response. Likewise, in response to the user 100 leaving the zone 98, the server pair 106 would return to their nominal fan speed operating levels. If the user 100 were to stand in the zones 97 and 98 simultaneously, then potentially both server pairs 105 and 106 would reduce their fan speeds in response. An alternative control scheme might reduce noise produced by each server pair 104, 105, 106 in response to a signal from any one of the sensors 93-95.

It should be observed that a noise-reduction mode may be implemented without the use of any sound level sensors. The servers 92 may instead be configured to automatically reduce fan speed and optionally reduce CPU load by predetermined amounts when the user 100 stands in a respective one of the zones 96-98. Alternatively, sound levels may be computed or estimated as a function of a fan or blower speed without expressly detecting the sound levels.

The five-server rack 86 illustrates an alternative sensor configuration. The five-server rack 86 includes five servers generally indicated at 94. A group-specific presence sensor 116 is associated with all five of the servers 94. Accordingly, the group-specific presence sensor 116 is configured for sensing the positioning of a user 102 anywhere in the zone 99. The presence sensor 116 senses the presence of the user 102 in the zone 99 and generates one or more signals in response. A controller or CPU may, in response to receiving the one or more signals, selectively reduce a CPU load and fan speed on each of the servers 94.

The eight-server rack 88 includes eight servers 150. In addition to any on-board fans for individually cooling the servers 150, the eight-server rack 88 includes a blower section 152 for cooling the eight-server rack 88 generally. A presence sensor 156 is associated with the blower 153; a presence sensor 157 is associated with the blower 154, and a presence sensor 158 is associated with the blower 155. Thus, the presence sensors 156, 157, 158 are device-specific, each generating signals for controlling a specific one of the associated blowers 153, 154, 155 in response to the positioning of a user in one of the zones 161, 162, 163.

In addition to servers, sound levels produced in association with other electronic components may be controlled according to the invention. For example, the electronic panel 90 houses various miscellaneous electronic component 171, 172, 173. Each component 171-173 is shown as including an optional sound level sensor and an associated presence sensor. For example, a device-specific presence sensor 174 and an optional device-specific sound level sensor 175 are uniquely associated with the electronic component 171. When a user 103 stands in a zone 170 associated with the electronic component 171, the presence sensor 174 detects the user's presence and generates a signal in response. The optional sound level sensor 175 may detect whether a sound level within the zone 170 is above a predetermined threshold and generate a signal in response. In response to the signals, the electronic component 171 may be configured to reduce a fan speed or other airflow parameter and optionally reduce a processor load (if the electronic component 171 includes a processor) or other parameter related to the generation of heat.

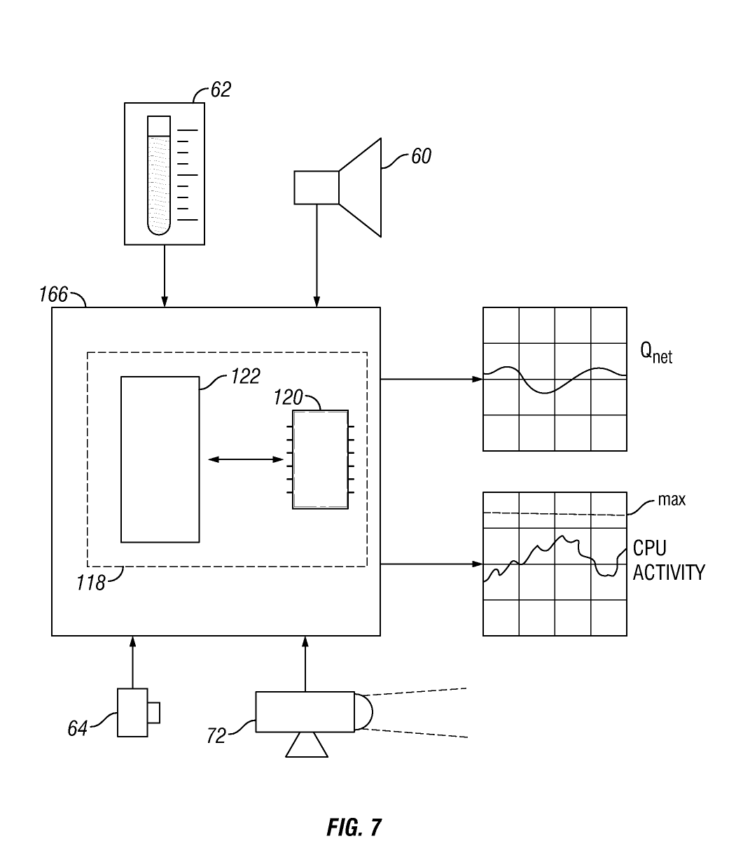

FIG. 7 is a schematic diagram illustrating one possible operational configuration of a controller 166 for receiving presence-related and optional sound-related signals and selectively controlling airflow parameters in response, as part of a noise-reduction mode of operation. The controller 166 contains logic circuitry 118, which may include at least one CPU 120, as well as any software 122 containing algorithms for selectively reducing noise levels in a computer system according to the invention. Non-limiting examples of software include firmware, resident software, and microcode. The controller 166 is in electronic communication with the optional sound level sensor 60, the temperature sensor 62, the door sensor 64, and the presence sensor 72. These sensors generate electronic signals and input the electronic signals to the controller 166. The controller 166 processes the electronic signals from the sensors and generates electronic output signals in response, to control Qₙₑₜ and processor load. The controller 166 may physically reside on an electronic component to be controlled or may be remotely positioned with respect to an electronic component to be controlled.

In one optional embodiment, the controller 166 continuously monitors signals from the sound level sensor 60 and, using the logic circuitry 118, compares the actual sound level to a selected value of dBₘₐₓ programmed into the logic circuitry 118. If signals from the sensors indicate the entry or presence of a person, the controller 166 may then throttle the computer system accordingly. For example, if the sound level sensor 60 indicates a sound level above dBₘₐₓ, the door sensor 64 indicates a door is opened, and the presence sensor 72 indicates the possible presence of a person in the computer room, then the controller 166 may reduce Qₙₑₜ to reduce the sound level. The controller may reduce Qₙₑₜ by, for example, selectively reducing the velocity of air through one or more blowers, turning off some of the blowers, or cycling one or more of the blowers ON/OFF. Relying on signals from the sound level sensor 60, the controller 166 may control Qₙₑₜ to maintain the sound level at less than dBmax.

It should also be recognized that because there is a known or empirically determinable relationship between fan speed and sound levels, it is possible to reduce sound levels of the computer system in a reproducible manner by simply regulating the fan speeds. Accordingly, it would not be necessary to incorporate sound level sensors or determine the actual sound levels in the room during operation of the computer system. Rather, it is sufficient to regulate fan speeds to no more than a predetermined rate in order to accomplish the desired limit of sound level whenever a person was detected as being present. Various embodiments of the invention can thus be modified so that the step of monitoring sound levels is substituted with a step of monitoring or detecting the fan speed or another similar variable, such as fan motor voltage or current, that might serve as a surrogate for sound level.

In addition to managing sound levels in the room to prevent hearing damage, the controller 166 may also manage temperature levels to prevent overheating of a computer system. A potential temperature increase caused by the reduction of airflow through the computer system may be avoided by selectively decreasing processor load whenever Qₙₑₜ is reduced. For instance, if the controller 166 detects a temperature rise, the controller 166 may gradually reduce processor load to maintain temperature below a value of Tₘₐₓ associated with the computer system. Alternatively, the controller 166 may reduce processor load a predetermined amount sufficient to prevent overheating while in a noise reduction mode.

The controller 166 may continuously monitor input signals from the various sensors to determine when a person exits the computer room. For example, a signal from the door sensor 64 is one indication (albeit inconclusive) that a person previously detected in the room may be exiting the room. Another indication of a person exiting the room is the absence of detected motion for a period of time. The controller 166 may subsequently increase Qₙₑₜ and processor load in response to one or both of these indications. While increasing processor load, the controller 166 may also control the blowers to increase Qₙₑₜ and maintain proper cooling. Again, feedback provided by the temperature sensor 62 allows the controller 166 to maintain a safe operating temperature.

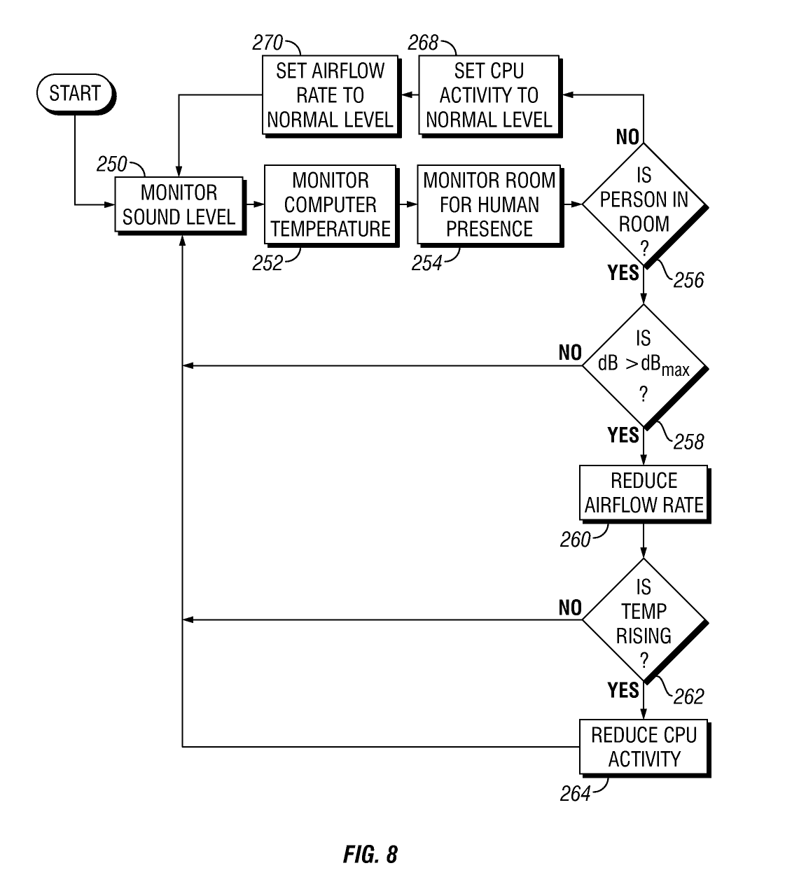

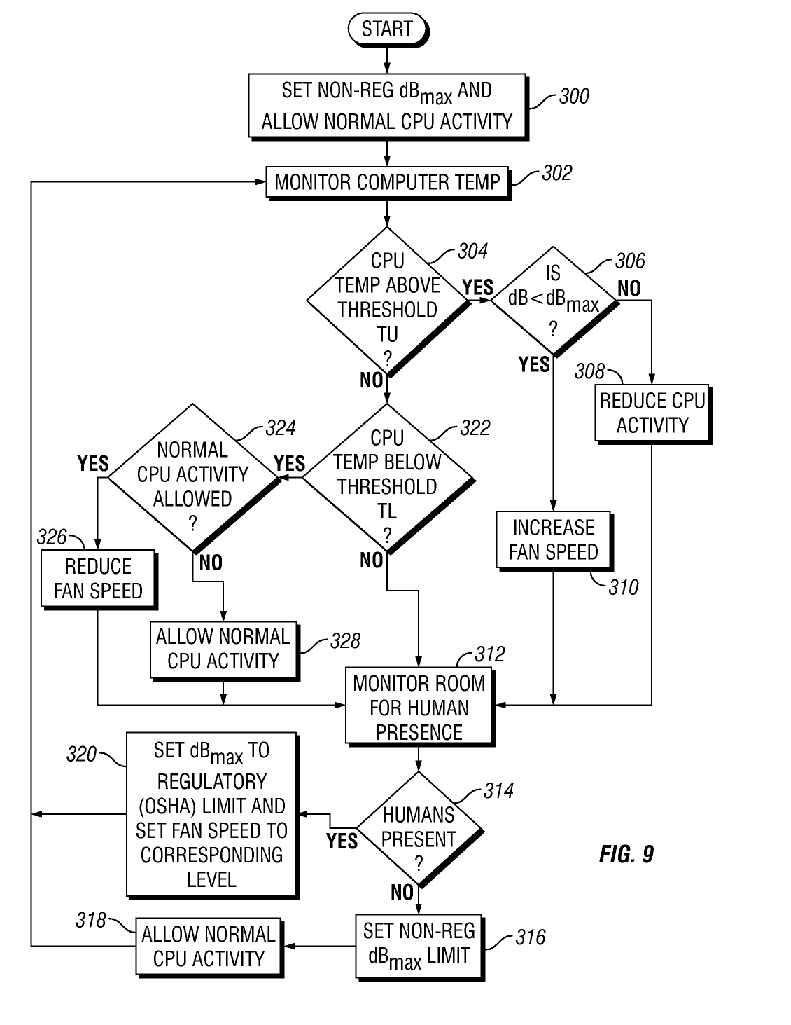

FIG. 8 is a flowchart of one embodiment of a process of controlling sound level within a predetermined distance from a computer system, and optionally in an enclosed space about the computer system, as part of a noise-reduction mode of operation. In step 250, sound level is monitored, such as with an electronic sound level sensor. In step 252, temperatures in the computer system are monitored, such as with one or more temperature sensors. In step 254, the entry and/or presence of a person into the computer room and/or presence of a person in proximity to an electronic component or group of electronic components may be detected/monitored. A position sensor, a motion detector, a door sensor, one or more pressure pads, or a combination thereof may be used. If a person is detected in the room (step 256) and the sound level exceeds a maximum allowable sound level dBₘₐₓ (step 258), then the airflow rate through the computer system is reduced in step 260. However, if the computer system is already operating within a safe sound level when the entry and/or presence of a person is detected (step 256), then it is not necessary to take any further steps directed at reducing the noise produced by the computer system. For example, the computer system may already be operating within a safe sound level during times of decreased activity, such as after-hours and on weekends. If no human presence is detected in step 256, the processor load or CPU activity may be operated normally (step 268) and the airflow rate may also be operated at a normal level (step 270).

The reduction in airflow rate (step 260) may cause a temperature in the computer system to increase. If a temperature is detected to be increasing in step 262, then the computer system may be controlled to reduce processor load according to step 264. The extent to which processor load is reduced may depend on how close the temperature is to its maximum allowable temperature or how quickly the temperature is rising. For example, if the temperature is already close to a predetermined maximum temperature Tₘₐₓ, or if the temperature starts increasing rapidly after reducing airflow rate, then the processor load may need to be significantly reduced to prevent overheating. However, if the temperature is already well below Tₘₐₓ, or does not increase rapidly, then the processor load may require very little reduction in processor load. In some instances, such as during off-peak periods, the system may remain safely below Tₘₐₓ without reducing processor load at all. In an alternative embodiment, the processor load may be directly controlled, while allowing the airflow rate to slowly adjust downwardly in accordance with a lower level of processor load and therefore a lower level of heat generation. While this alternative may better protect the CPU from overheating and provide a simplified control scheme, it has the disadvantage of producing a delayed reduction in the sound level.

After determining that dB is not greater than dBmax in step 258 or taking any necessary measures to reduce the airflow rate in step 260 or reduce CPU activity in step 264, the process returns to monitoring sound level, computer temperature and human presence is steps 250, 252, and 254. So long as at least one person is detected in the computer room, the computer system may remain in a reduced airflow and/or reduced activity state, as necessary, to avoid harmful sound levels greater than dBmax. After all occupants have been determined to have exited the computer room in step 256, the computer system may increase processor load and airflow to normal levels. For example, in step 268, any restriction on the processor load may be removed so that the processor is allowed to increase throughput. In step 270, any restrictions on the airflow rate may be removed so that the airflow rate may be safely increased to levels that are capable of generating a sound level in excess of dBmax. Still, it is an optional feature that the administrator could apply other, most likely higher, limits on sound level during normal operation in the absence of a person being in the room or area.

FIG. 9 is a flowchart of an alternative process according to the invention. In step 300, a computer system may be operated at an optional “non-regulatory” sound level threshold dBmax1. The value of dBmax1 may be higher than a “regulatory” sound level threshold dBmax2, such as may be imposed by OSHA or other regulatory body. Normal, unrestricted CPU activity may occur at dBmax1. In step 302, one or more temperatures T of the computer system may be monitored, such as a CPU temperature. An upper temperature threshold TU and a lower temperature threshold TL are selected. Different subroutines or other processes may be executed depending on whether T exceeds TU in step 304.

According to step 304, if T>TU and if the sound level dB is greater than (i.e., not less than or equal to) dBmax (step 306), then CPU activity is reduced (step 308). If T>TU in step 304, but the sound level dB is less than dBmax in step 306, then the fan speed may be increased (step 310). In either of these conditions, human presence is then monitored according to step 312. In step 314, if human presence is not detected, then the computer system may continue to operate according to an optional non-regulatory sound level threshold dBmax1 (step 316) and at normal, unrestricted CPU activity (step 318). If human presence is detected in step 314, then the computer system shifts to operating at the regulatory sound level dBmax2 (step 320). After step 318 or step 320 is performed, the process returns to step 302.

If the temperature(s) are less than TU in step 304, however, then the next inquiry is whether the temperature(s) are below TL in step 322. If T<TL (step 322) and if the computer system is operating at a normal, unrestricted levels (step 324), then fan speed is reduced in step 326. However, if T<TL (step 322) and if the computer system is not already operating at normal, unrestricted levels (step 324), then the CPU is allowed to operate at a normal activity level (step 328) before the process proceeds to step 312.

It should be recognized that the invention may take the form of an embodiment containing hardware and/or software elements. Non-limiting examples of software include firmware, resident software, and microcode. More generally, the invention can take the form of a computer program product accessible from a computer-readable medium providing program code for use by or in connection with a computer system such as the computer system 10, 110, or 130. The types of computers suitable for use with the invention include rack server systems. For the purposes of this description, a computer-usable or computer readable medium can be any apparatus that can contain, store, communicate, propagate or transport the program for use by or in connection with the instruction execution system, apparatus or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W), and DVD.

A data processing system suitable for storing and/or executing program code typically includes at least one processor coupled directly or indirectly to memory elements through a system bus. The memory elements can include local memory employed during actual execution of the program code, bulk storage, and cache memories that provide temporary storage of at least some program code in order to reduce the number of times code must be retrieved from bulk storage during execution.

Input/output (I/O) devices such as keyboards, displays, or pointing devices can be coupled to the system, either directly or through intervening I/O controllers. Network adapters may also be used to allow the data processing system to couple to other data processing systems or remote printers or storage devices, such as through intervening private or public networks. Modems, cable modems, Ethernet cards, and wireless network adapters are examples of network adapters.

The terms “comprising,” “including,” and “having,” as used in the claims and specification herein, shall be considered as indicating an open group that may include other elements not specified. The terms “a,” “an,” and the singular forms of words shall be taken to include the plural form of the same words, such that the terms mean that one or more of something is provided. The term “one” or “single” may be used to indicate that one and only one of something is intended. Similarly, other specific integer values, such as “two,” may be used when a specific number of things is intended. The terms “preferably,” “preferred,” “prefer,” “optionally,” “may,” and similar terms are used to indicate that an item, condition or step being referred to is an optional (not required) feature of the invention.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method of controlling sound level of a computer system, comprising:
detecting the presence of one or more person within a selected zone about the computer system and generating an electronic signal representative of the detected presence; and
limiting an airflow rate through the computer system in response to the electronic signal representative of the detected presence.

2. The method of claim 1, further comprising:
determining a sound level of the computer system and generating an electronic signal representative of the sound level; and
limiting the airflow rate to limit the sound level according to a predefined sound-level setpoint

3. The method of claim 1, further comprising decreasing a processor load in response to the electronic signal representative of the detected presence.

4. The method of claim 1, further comprising:
detecting temperature within the computer system and generating an electronic signal representative of the temperature; and
selectively decreasing the processor load such that the temperature is at or below a predefined maximum temperature.

5. The method of claim 1, wherein detecting the presence of the one or more person within the selected zone comprises detecting the positioning or movement of an object within the selected zone and generating a signal in response.

6. The method of claim 1, wherein detecting the presence of the one or more person within the selected zone comprises transmitting an optical or infrared beam to the selected zone.

7. The method of claim 1, wherein detecting the presence of the one or more person within the selected zone comprises detecting a change in temperature within the selected zone to within a temperature range of between 95 and 105 degrees Fahrenheit.

8. The method of claim 1, wherein detecting the presence of the one or more person within the selected zone comprises detecting forces at one or more locations along a floor.

9. The method of claim 8, wherein detecting the presence of the one or more person within the selected zone comprises detecting forces at a predefined sequence of locations along the floor.

10. The method of claim 1, wherein detecting the presence of the one or more person within the selected zone further comprises detecting an opening of a door.

11. The method of claim 1, wherein detecting the presence of the one or more person within the selected zone further comprises:
reading an ID associated with each person entering or exiting the selected zone; and
tracking how many people are within the selected zone.

12. A system for controlling sound level of a computer system, the computer system having one or more blowers and one or more processors, the apparatus comprising:
a presence sensor for generating an electronic signal responsive to the presence of a person within the selected zone; and
a controller in electronic communication with the presence sensor for controlling the one or more blowers and the one or more processors and selectively decreasing one or both of an airflow rate and a processor load in response to the signal from the position detector.

13. The system of claim 12, further comprising:
a sound level sensor for generating an electronic signal representative of sound level within the selected zone,
wherein the controller is in electronic communication with the sound level sensor for selectively decreasing one or both of an airflow rate and a processor load in response to the signal from the position detector and the signal from the sound level sensor.

14. The apparatus of claim 13, wherein, the controller is configured to decrease the airflow rate until the sound level within the selected zone from the computer system is below a predefined sound-level setpoint in response to both the signal from the sound level detector and the signal from the position detector.

15. The apparatus of claim 12, further comprising:
a temperature sensor for sensing a temperature of the computer system and generating an electronic signal representative of the sensed temperature; and
wherein the controller is in electronic communication with the temperature sensor and is configured for selectively decreasing the processor load to maintain the temperature below a predefined maximum temperature.

16. The apparatus of claim 12, wherein the presence sensor comprises one of an optical position sensor, an RF sensor, and an IR sensor.

17. The apparatus of claim 12, wherein the presence sensor comprises a temperature sensor configured for sensing temperatures within a range of about 95 to 105 degrees Fahrenheit.

18. The apparatus of claim 12, wherein the presence sensor comprises a door sensor in electronic communication with the controller for detecting an opening of a door to an enclosed space about the computer system and generating an electronic signal in response.

19. The apparatus of claim 18, wherein the presence sensor further comprises an ID sensor in electronic communication with the controller for reading user IDs and tracking people entering and exiting the enclosed space.

20. A computer program product comprising a computer usable medium including computer usable program code for controlling sound level within a selected zone about a computer system, the computer program product including:
computer usable program code for detecting the presence of one or more person within a selected zone about the computer system and generating an electronic signal representative of the detected presence; and
computer usable program code for decreasing an airflow rate through the computer system in response to the electronic signal representative of the detected presence.
